(19) United States
(12) Patent Application Publication
(10) Pub. No.: US 2010/0195179 A1
(43) Pub. Date: Aug. 5, 2010

(54) HOLOGRAM REPRODUCING DEVICE AND HOLOGRAM REPRODUCING METHOD

(75) Inventors: Kazushi Uno, Kawasaki (JP); Koichi Tezuka, Kawasaki (JP); Hiroyasu Yoshikawa, Kawasaki (JP); Yasumasa Iwamura, Kawasaki (JP); Yuzuru Yamakage, Kawasaki (JP); Satoshi Shimokawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/724,905

(22) Filed: Mar. 16, 2010

Related U.S. Application Data
(63) Continuation of application No. PCT/JP2007/069441, filed on Oct. 4, 2007.

(51) Int. Cl. G03H 1/26

(52) U.S. Cl. 359/22

(57) ABSTRACT

A hologram reproducing device includes a splitter for splitting a reference beam, during reproduction, into a main beam and sub-beams forming incidence directions spatially shifted from the main beam. The hologram reproducing device also includes: an incidence direction variable irradiator for changing the incidence directions of the main beam and the sub-beams; a servo beam detector for detecting a portion of the reproduction beam generated in accordance with the sub-beams; and a beam receiving unit for receiving the main portion of the reproduction beam generated in accordance with the main beam. A reproducer reproduces an image obtained by the beam receiving unit when the main beam coincides with the incidence direction at which the received light of the beam receiving unit becomes equal to or greater than a prescribed level, with the intensity of the reference beam kept uniform, on the basis of the servo beam detection results.

### TECHNICAL FIELD

The present invention relates to a hologram reproducing device and a hologram reproducing method for reproducing an image based on a hologram recorded on a hologram recording medium.

### BACKGROUND ART

One hologram recording method is a so-called angular multiplexing recording method in which the angle of incidence of a reference light beam with respect to a hologram recording medium is varied and a hologram is recorded each time the angle of incidence becomes a prescribed recording angle. Patent Document 1 discloses a conventional hologram reproducing method for reproducing an image based on a hologram from a hologram recording medium on which holograms have been recorded in multiplexed fashion by a recording medium of this kind. In the method disclosed in Patent Document 1, an image based on a hologram is reproduced in the following manner.

For example, as illustrated in FIG. 9, if holograms are recorded in multiplexed fashion whenever the angle of incidence of a reference beam becomes a recording angle θ1, θ2 and θ3, these angles being formed at a uniform angular interval apart Δθ, then during reproduction, a reference beam is irradiated onto the hologram recording medium while changing the angle of incidence in a similar manner to during recording. In this case, when the angle of incidence of the reference beam coincides with a recording angle θ1, θ2 or θ3, then a reproduction beam of sufficient light intensity is generated by diffraction with the hologram. By forming an image of the reproduction beam in a beam receiving unit, such as a CCD, an image based on a hologram is reproduced.

Examples of methods for aligning the angle of incidence of the reference beam with the recording angles θ1, θ2 and θ3 in this way are a peak hold determination method or a differential determination method. In a peak hold determination method, the received light quantity of a reproduction beam is measured while varying the angle of incidence of the reference beam at a uniform angular sweep rate by means of an incidence angle variable irradiator, and the angle of incidence of the reference beam at which an optimal peak state is obtained is confirmed when this received light quantity changes from increase to decrease. A differential determination method measures the received light quantity of a reproduction beam while variably controlling the angular sweep rate at which the angle of incidence of the reference beam is altered, and confirms the angle of incidence of the reference beam at which the optimal peak state is obtained, through change prediction, by determining the rate of change of the received light quantity with a differential circuit.

Patent Document 1: Japanese Laid-open Patent Publication No. 2006-171589

However, in a conventional hologram reproducing method, there has been margin for improving the peak hold method or differential determination method. In other words, in a peak hold determination method, even if the received light quantity has exceeded a peak state, the angle of incidence of the reference beam must be changed for some time, and therefore the incidence angle variable irradiator must perform a retrogressive operation. This places a large load on the incidence angle variable irradiator, and also causes a problem in that the operation of aligning the angle of incidence with the recording angle cannot be carried out at high speed. On the other hand, in a differential determination method, it is not possible significantly to speed up the operation of aligning the angle of incidence with a recording angle, since the angular sweep rate is controlled variably, and there is also a problem in that a calculation circuit, such as a differential circuit, or the like, is required, and therefore the circuit composition becomes complicated.

### DISCLOSURE OF THE INVENTION

The present invention has been proposed in view of the circumstances described above. It is an object of the present invention to provide a hologram reproducing device and a hologram reproducing method whereby a reproducing operation can be carried out at high speed, by means of a simple structure.

In order to achieve the object stated above, embodiments of the present invention incorporate the following technical means.

The hologram reproducing device provided by a first aspect of the present invention is a hologram reproducing device for reproducing an image based on a hologram by irradiating a reference beam onto a hologram recording medium on which holograms have been recorded in multiplexed fashion by changing the incidence direction of the reference beam during recording, the incidence direction of the reference beam being changed during reproduction in a similar fashion to during recording, and by receiving a reproduction beam from the hologram recording medium, the hologram reproducing device comprising: a reproduction reference beam splitter for splitting the reference beam, during reproduction, into a main beam forming a main incidence direction with respect to the hologram recording medium, and sub-beams forming incidence directions spatially shifted from the main beam; an incidence direction variable irradiator for irradiating the main beam and the sub-beams onto the hologram recording medium while varying the incidence directions of the main beam and the sub-beams; a servo beam detector for detecting as servo beams a portion of the reproduction beam which is generated corresponding to the sub-beams, while the angle of incidence of the main beam and the sub-beams changes; a beam receiving unit for receiving the main portion of the reproduction beam generated corresponding to the main beam; and a reproducer for identifying the incidence direction of the main beam at which the received light quantity of the beam receiving unit becomes equal to or greater than a prescribed level, when the intensity of the reference beam is kept uniform, on the basis of the servo beam detection results, and reproducing an image obtained by the beam receiving unit when the main beam coincides with the identified incidence direction.

Preferably, the incidence direction variable irradiator is configured such that the incidence direction of the main beam is varied within a prescribed reference plane which intersects with the hologram recording medium, and the reproduction reference beam splitter is configured so as to generate, as the sub-beams, a first sub-beam and a second sub-beam which are shifted with respect to each other when projected to the reference plane.

Preferably, the first sub-beam and the second sub-beam are generated on both sides of the main beam, the main beam being central between same, when projected onto the reference plane.

Preferably, the first sub-beam and the second sub-beam are also generated on both sides of the main beam, the main beam being central between same, when projected onto a plane which is perpendicular to the reference plane.

Preferably, the servo beam detector comprises a mechanism for carrying out calculation processing using a first photosensor and a second photosensor which detect at the least the intensity of the servo beams corresponding respectively to the first sub-beam and the second sub-beam, and performing feedback control so as to achieve a prescribed target value, as a result of the calculation processing.

Preferably, the medium used as the hologram recording medium is a medium on which a hologram has been recorded each time the angle of incidence of the reference beam becomes a prescribed recording angle, the recording angles being situated at uniform angular intervals apart, and the angles formed respectively between the main beam and the first sub-beam and the second sub-beam, when the first and second sub-beams are projected to the reference plane, are set to be a different value from the uniform angular interval.

The hologram reproducing method provided by a second aspect of the present invention is a hologram reproducing method for reproducing an image based on a hologram by irradiating a reference beam onto a hologram recording medium on which holograms have been recorded in multiplexed fashion by changing the incidence direction of the reference beam during recording, the incidence direction of the reference beam being changed during reproduction in a similar fashion to during recording, and by receiving a reproduction beam from the hologram recording medium, the method comprising: a reproduction reference beam splitting step of splitting the reference beam, during reproduction, into a main beam forming a main incidence direction with respect to the hologram recording medium, and sub-beams forming incidence directions spatially shifted from the main beam within a prescribed reference plane which intersects perpendicularly with the hologram recording medium; an incidence direction variable irradiation step of irradiating the main beam and the sub-beams onto the hologram recording medium while varying the incidence directions of the main beam and the sub-beams; a servo beam detection step of detecting a portion of the reproduction beam which is generated corresponding to the sub-beams, while the angle of incidence of the main beam and the sub-beams changes; a beam receiving step of receiving the main portion of the reproduction beam generated corresponding to the main beam; and a reproduction step of identifying the incidence direction of the main beam at which the received light quantity in the beam receiving step becomes equal to or greater than a prescribed level, when the intensity of the reference beam is kept uniform, on the basis of the servo beam detection results, and reproducing an image obtained by the beam receiving unit when the main beam coincides with the identified incidence direction.

### BRIEF DESCRIPTION OF THE DRAWINGS

FIG. 1 is a general compositional view illustrating one embodiment of a hologram reproducing device according to the present invention;

FIG. 2 is a principal part perspective diagram of the hologram reproducing device illustrated in FIG. 1;

FIG. 3 is a principal part side diagram of the hologram reproducing device illustrated in FIG. 1;

FIG. 4 is a principal part front diagram of the hologram reproducing device illustrated in FIG. 1;

FIG. 5 is an illustrative diagram for describing the optical characteristics during reproduction of a hologram;

FIG. 6 is an illustrative diagram for describing the operation during reproduction of a hologram;

FIG. 7 is a flowchart diagram illustrating an operating procedure during reproduction of a hologram;

FIG. 8 is a principal part side diagram illustrating a further embodiment of a hologram reproducing device according to the present invention; and

FIG. 9 is an illustrative diagram for describing a conventional hologram reproducing method.

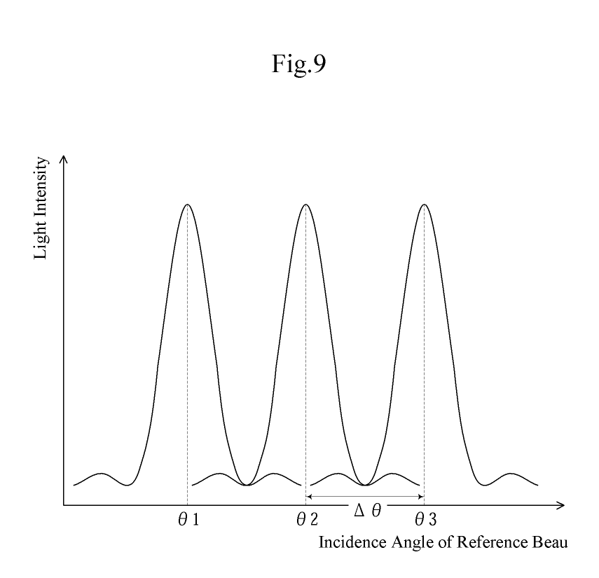

### BEST MODE FOR CARRYING OUT THE INVENTION

Preferred embodiments of the present invention will be described below with reference to the drawings.

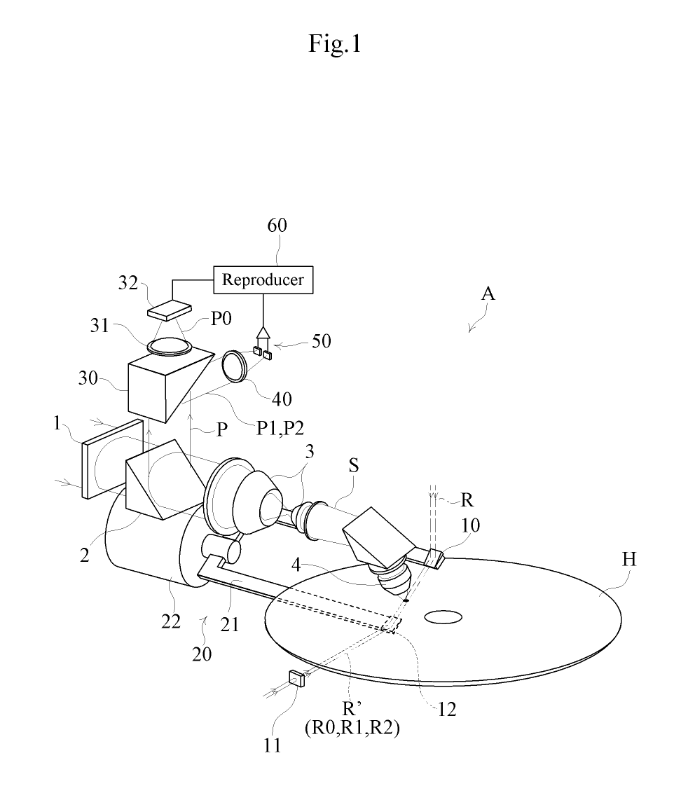

FIGS. 1 to 7 illustrate one embodiment of a hologram reproducing device according to the present invention. As illustrated in FIG. 1, the hologram reproducing device A according to the present embodiment reproduces an image based on a hologram by receiving a reproduction beam P from a hologram recording medium H by irradiating a reproduction reference beam R′ while varying the incidence direction similarly to during recording, onto the hologram recording medium H on which a hologram has been recorded in multiplexed fashion by varying the incidence direction of a recording reference beam R during recording. This hologram reproducing device A also has a hologram recording function, in addition to a hologram reproducing function.

The hologram reproducing device A includes a recording light optics system for irradiating a recording beam S, a reference light optics system for irradiating a recording reference beam R or recording reference beam R′ while variably controlling the incidence direction with respect to a hologram recording medium H, and a reproduction light optics system for reproducing an image based on a hologram from a reproduction beam P. Outside the drawings, there are provided: a light source that emits laser light, a collimating lens which converts laser light into parallel light, a beam splitter for splitting the laser light into a reproduction beam S and reference beams R and R′, and a light quantity ratio adjusting device.

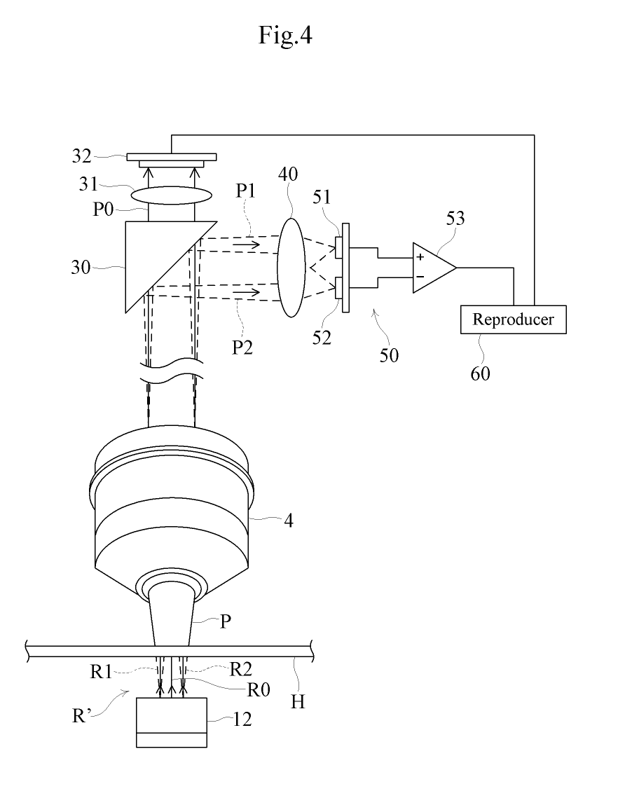

The recording light optics system is constituted by a spatial light modulator 1, a first half mirror 2, a relay lens 3 and an object lens 4. The reference light optics system is constituted by a recording mirror 10, a reproduction reference beam splitter 11, a reproduction mirror 12, and an incidence direction variable irradiator 20. The incidence direction variable irradiator 20 varies the incidence direction of the recording reference beam R and the reproduction reference beam R′, and is constituted by a U-shaped arm member 21 and a drive motor 22. The reproduction optics system is constituted by a second half mirror 30, a reproduction condensing lens 31, a beam receiving unit 32, a servo condensing lens 40, a servo beam detector 50 and a reproducer 60. As illustrated in FIG. 4, the servo beam detector 50 includes a first photosensor 51 and a second photosensor 52 which detect a portion of the reproduction beam P as servo beams P1 and P2, a main beam photosensor 53 which detects light emitted in a direction corresponding to a main beam R0, which is described hereinafter, and a differential amplifier 54 which outputs the differential between the light intensities output by the first and second photosensors 51 and 52, to the reproducer 60. The reproducer 60 consists of an electrical circuit, and the beam receiving unit 32, the servo beam detector 50 and the drive motor 22 are electrically connected to this reproducer 60. This reproduction light optics system and reference light optics system are composed to be movable reciprocally in the radial direction of the hologram recording medium H.

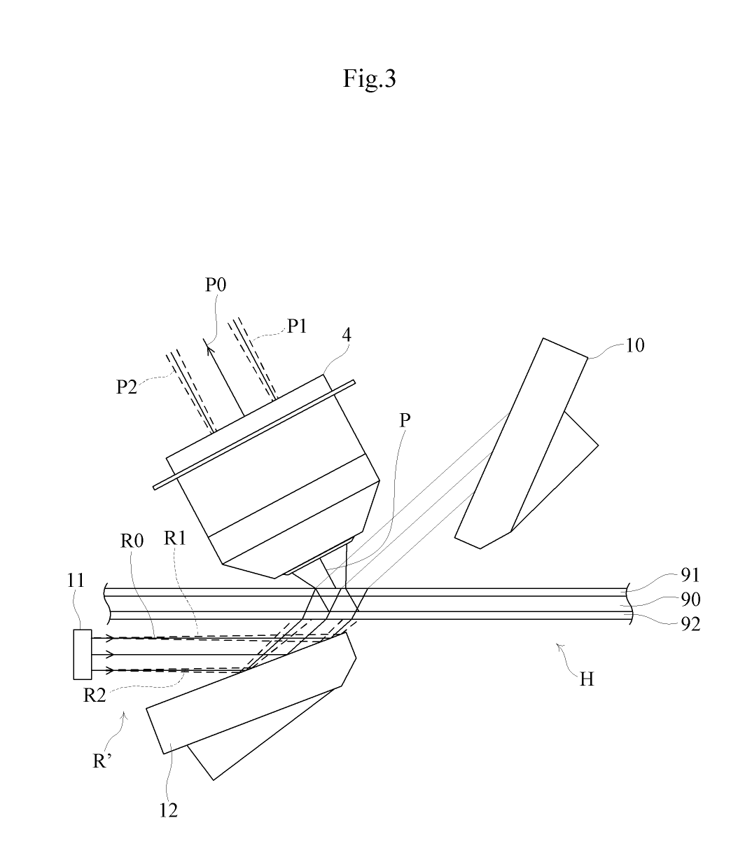

As illustrated in FIG. 3, the hologram recording medium H has a structure made up of a photopolymer recording layer 90, for example, as an intermediate layer, and transparent cover layers 91 and 92 laminated on either side of this recording layer 90. During recording, a recording beam S and a recording reference beam R are irradiated from the upper surface side of the hologram recording medium H. By this means, a hologram is recorded as an interference pattern in the recording layer 90. During reproduction, only the reproduction reference beam R′ is irradiated from the lower surface side of the hologram recording medium H, and a reproduction beam P is produced by means of this reproduction reference beam R′ being diffracted by the hologram.

For example, during recording, a laser beam emitted from a light source (not illustrated) is converted into parallel light by a collimating lens (not illustrated) and is then split into a recording beam S and a recording reference beam R by a beam splitter. The recording beam S is directed to the spatial light modulator 1, while the recording reference beam R is directed to the recording mirror 10. In a similar fashion to this, during reproduction, a laser beam from a light source is passed through a collimating lens and split by a beam splitter into a recording beam S and a reproduction reference beam R′, and the reproduction reference beam R′ is directed via the reproduction reference beam splitter 11 to the reproduction mirror 12. During reproduction, by the action of a light quantity ratio adjuster, almost all of the light emitted from the light source is formed into the reproduction reference beam R′, and all of the pixels of the spatial light modulator 1 are set to a shielded state in such a manner that not even the very faintest recording beam S is incident on the hologram recording medium H.

The spatial light modulator 1 consists, for example, of a transmissive liquid crystal display having a plurality of pixels, and modulates laser light input thereto into a recording beam S having a two-dimensional pixel pattern corresponding to the information to be recorded. The recording beam S emitted from the spatial light modulator 1 is directed to the relay lens 3 by passing through the first half mirror 2, and further passes through the object lens 4 to be irradiated onto a prescribed position on the hologram recording medium H. The object lens 4 is disposed in such a manner that the optical axis thereof has a prescribed inclination with respect to the hologram recording medium H.

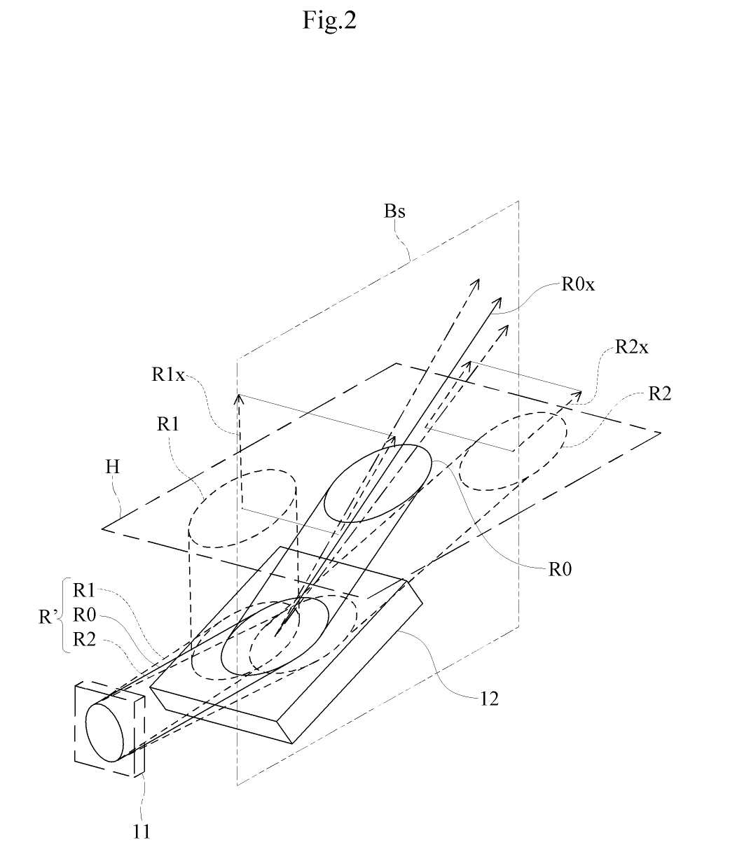

The recording mirror 10 is fixed to one end of the arm member 21 which is disposed on the upper surface side of the hologram recording medium H, and reflects the recording reference beam R which has traveled on a light path substantially perpendicular to the hologram recording medium H, in an oblique downward direction toward a prescribed position. The reproduction mirror 12 is fixed to the other end of the arm member 21 which is disposed on the lower surface side of the hologram recording medium H, and reflects the recording reference beam R′ which has traveled on a light path substantially parallel to the hologram recording medium H, in an oblique upward direction toward a prescribed position. The arm member 21 is rotated through a prescribed range by means of a drive motor 22 which has an axis of rotation disposed in the radial direction of the hologram recording medium H. By this means, the recording mirror 10 and the reproduction mirror 12 are caused to swing in unison in a prescribed reference plane which is perpendicular to the hologram recording medium H. This prescribed reference plane is the plane indicated by the thin double-dotted lines in FIG. 2, and is known as a Bragg plane Bs. The main axis of the recording reference beam R which is incident on the hologram recording medium H from the recording mirror 10, and the optical axis of the object lens 4, are contained in this Bragg plane Bs.

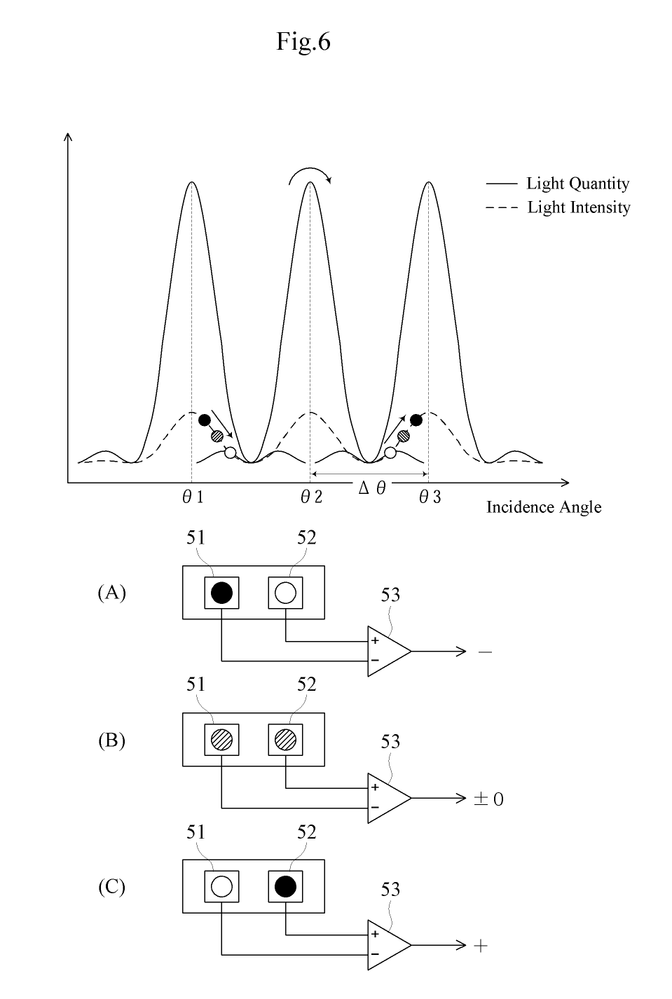

During recording, the recording mirror 10 is made to swing, and in accordance with this, a recording beam S is irradiated each time the angle of incidence of the recording reference beam R, for example, becomes a recording angle θ1, θ2 or θ3, these recording angles being separated by a uniform angular interval Δθ as illustrated in FIG. 6. The recording angles θ1, θ2 and θ3 are formed inside the Bragg plane Bs. Accordingly, holograms corresponding to the recording angles θ1, θ2 and θ3 are recorded in multiplexed fashion at the prescribed position on the hologram recording medium H.

The reproduction reference beam splitter 11 consists of a diffraction grating or prism, for example. As illustrated in FIGS. 2 to 4, the reproduction reference beam splitter 11 splits the incident reproduction reference beam R′ into a main beam R0 which forms a main incidence direction with respect to the hologram recording medium H and a first sub beam R1 and a second sub-beam R2 which are spatially shifted from this main beam R0. The main beam R0 accounts for approximately 80% of the whole light output and the first sub-beam R1 and the second sub-beam R2 account for approximately 10% each.

As illustrated in FIG. 2, the main axis R0x of the main beam R0 is contained in the Bragg plane Bs. By this means, the angle of incidence of the main beam R0 is formed inside the Bragg plane Bs. The main axes R1x and R2x of the first sub-beam R1 and the second sub-beam R2 are not parallel to any of a plane parallel to the hologram recording medium H, the Bragg plane Bs, or a plane that is perpendicular to both of these. In other words, if the three mutually perpendicular planes which include the Bragg plane Bs are taken as observation planes, then the incidence directions of the first sub-beam R1 and the second sub-beam R2 are different directions to all of these observation planes. If the main axes R1x and R2x of the first sub-beam R1 and the second sub-beam R2 are projected onto the Bragg plane Bs, then the main axis R0x of the main beam R0 is positioned between these two main axes R1x and R2x. The angle of incidence of the first sub-beam R1 and the second sub-beam R2 formed by projecting the main axis R1x and the main axis R2x onto the Bragg plane Bs in this way is called the projected angle of incidence. The amount of angular deviation between the projected angle of incidence of the first sub-beam R1 and the angle of incidence of the main beam R0, and the amount of angular deviation between the projected angle of incidence of the second sub-beam R2 and the angle of incidence of the main beam R0 are substantially equal, and these amounts of angular deviation are set to be a different value to the uniform angular interval Δθ during recording.

During reproduction, the reproduction mirror 12 is caused to swing and accordingly, the angle of incidence of the main beam R0 and the projected angle of incidence of the first sub-beam R1 and the second sub-beam R2 are changed. Nearly all of the reproduction reference beam R is occupied by the main beam R0, and when the angle of incidence of this main beam R0 coincides with a recording angle θ1, θ2 or θ3, a reproduction beam P of sufficient light quantity is produced. This reproduction beam P includes the main portion P0 which is generated corresponding to the main beam R0, and also includes the first servo beam P1 and the second servo beam P2 which are generated corresponding to the first sub beam R1 and the second sub-beam R2.

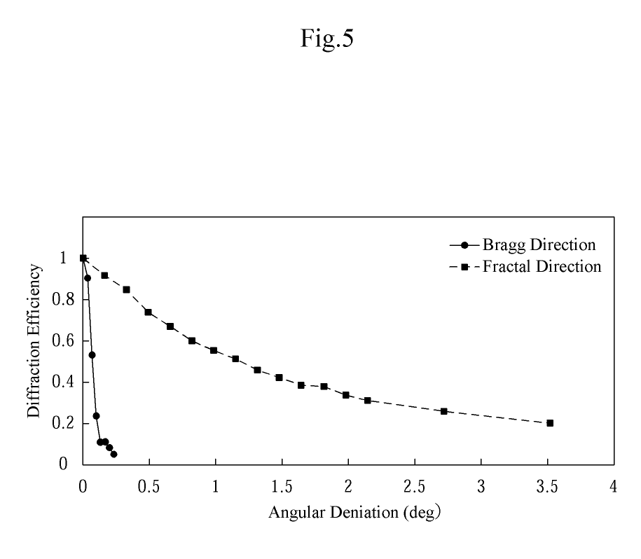

Here, as illustrated in FIG. 5, in general, if the reproduction reference beam R′ deviates in the Bragg direction following the Bragg plane Bs, with respect to the incidence direction of the recording reference beam R, then the diffraction efficiency declines dramatically in response to this angular deviation. On the other hand, there is a fractal plane (not illustrated) which is perpendicular to both the plane parallel to the hologram recording medium H and the Bragg plane Bs, and if the reproduction reference beam R′ diverges in a fractal direction following this fractal plane, then the diffraction efficiency corresponding to the amount of angular deviation does not decline as dramatically as the diffraction efficiency corresponding to the amount of angular deviation in the Bragg direction. Based on optical characteristics of this kind, the first sub-beam R1 and the second sub-beam R2 which are contained in the reproduction reference beam R′ are made to deviate in both the Bragg direction and the fractal direction with respect to the main beam R0. Since the first sub-beam R1 and the second sub-beam R2 deviate in the fractal direction as well, then the first servo beam P1 and the second servo beam P2 progress in different emission directions to the main portion P0 of the reproduction beam P and are detected reliably by the first photosensor 51 and the second photosensor 52 which are disposed in mutually different light collecting positions.

As illustrated in FIG. 4, the main portion P0 of the reproduction beam P is focused on the beam receiving unit 32 via the second half mirror 30 and the reproduction condensing lens 31. Furthermore, the intensity of a portion of this beam is detected by the main beam photosensor 53. The first servo beam P1 and the second servo beam P2 are reflected by the second half mirror 30 and then passed through the servo condensing lens 40, and the intensity thereof is detected by the first photosensor 51 and the second photosensor 52.

As illustrated in FIG. 6, the received light quantity detected by the main beam photosensor 53 in accordance with the angle of incidence of the main beam R0 exhibits a trend of variation as indicated by the solid line. The light intensity of the first servo beam P1 and the second servo beam P2 obtained by the first photosensor 51 and the second photosensor 52 in accordance with the projected angle of incidence of the first sub-beam R1 and the second sub-beam R2 exhibits a trend of variation as indicated by the dotted line. More specifically, for example, as indicated by FIG. 6(A), in a state where a high-level light intensity is detected by the first photosensor 51, while simultaneously a low-level light intensity is detected by the second photosensor 52, the angle of incidence of the main beam R0 is in a state of not reaching the recording angle θ2. Conversely, as indicated by FIG. 6(C), in a state where a low-level light intensity is detected by the first photosensor 51, while simultaneously a high-level light intensity is detected by the second photosensor 52, the angle of incidence of the main beam R0 is in a state of having exceeded the recording angle θ2. On the other hand, as illustrated in FIG. 6(B), if the light intensity detected by the first photosensor 51 and the second photosensor 52 is the same level, then the angle of incidence of the main beam R0 is in a state of coinciding with the recording angle θ2. In this way, if the light intensity of the first servo beam P1 and the second servo beam P2 are detected at the same level, then the received light quantity detected by the main beam photosensor 53 reaches a peak level, and the main portion P0 of the reproduction beam P is focused on the beam receiving unit 32 with sufficient received light quantity, each time this occurs.

The beam receiving unit 32 is constituted by a CCD, for example; the light reception timing is controlled by the reproducer 60, and the beam receiving unit 32 outputs a hologram image obtained by focusing the reproduction beam, to the reproducer 60. The first photosensor 51 and the second photosensor 52 detect the intensity of the first servo beam P1 and the second servo beam P2, and output signals corresponding to the respective beam intensities (beam intensity signals) to the differential amplifier 54. The differential amplifier 54 finds the difference between the two beam intensity signals and outputs a signal corresponding to this difference (a differential signal), to the reproducer 60. The detection signal from the main beam photosensor 53 is input to the reproducer 60. The reproducer 60 causes the beam receiving unit 32 to output a hologram image each time the differential signal reaches a zero level, and reads out the originally recorded information by reproducing this hologram image. Furthermore, the reproducer 60 carries out prescribed processing on the basis of the detection signal from the main beam photosensor 53.

Next, the reproduction operation of the hologram reproducing device A will be described.

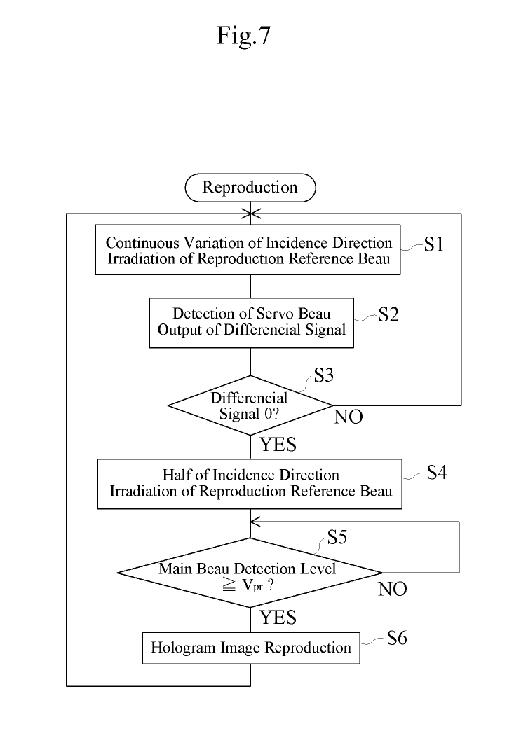

As illustrated in FIG. 7, firstly, the incidence direction variable irradiator 20 operates so as to continuously vary the incidence direction of the reproduction reference beam R′ at a uniform angular sweep rate. By this means, the reproduction reference beam R′ is irradiated onto a prescribed position on the hologram recording medium H while varying the angle of incidence of the main beam R0 and the projected angles of incidence of the first and second servo beams R1 and R2 (S1).

If the reproduction reference beam R′ is irradiated in this way, then reproduction beam P is generated in accordance with this. The first and second servo beams P1 and P2 corresponding to the first and the second sub-beams R1 and R2 are included in this reproduction beam P. Furthermore, the light forming the main portion P0 corresponding to the main beam R0 is also included in the reproduction beam P. The first servo beam P1 is detected by the first photosensor 51 and the second servo beam P2 is detected by the second photosensor 52. Beam intensity signals corresponding to the first and second servo beams P1 and P2 are output from the first and second photosensors 51 and 52, and the differential amplifier 54 outputs a differential signal corresponding to the differential between these beam intensity signals (S2).

In this case, if the beam intensity detected by the first photosensor 51 coincides with the beam intensity detected by the second photosensor 52, then a differential signal of zero level is output from the differential amplifier 54 (S3: YES). This is a state where, as illustrated by the graph and the example indicated by (B) in FIG. 6, the projected angle of incidence of the first sub-beam R1 is between the two recording angles θ1 and θ2, the beam intensity of the first servo beam P1 has an intermediate level, the projected angle of incidence of the second sub-beam R2 is between the two recording angles θ2 and θ3, and the beam intensity of the second servo beam P2 has an intermediate level. More specifically, this is a state where the angle of incidence of the main beam R0 matches the recording angle θ2, and a portion of the light forming the main portion P0 of the reproduction beam P is detected at an approximate peak value which is equal to or higher than the average, by the main beam photosensor 53.

If the angle of incidence of the main beam R0 coincides with the recording angle θ2 in this way (S3: YES), then the incidence direction variable irradiator 20 temporarily halts the operation of varying the incidence direction of the reproduction reference beam R′. By this means, the reproduction reference beam R′ is irradiated in a state where the angle of incidence thereof matches the recording angle θ2 (S4).

In this case, in the beam receiving unit 32, a main portion P0 of the reproduction beam having sufficient light quantity is obtained, and after confirming that the output of the first photosensor 51, the second photosensor 52 and the main beam photosensor 53 have reached a prescribed level, it is considered that the beam has been received successfully. For example, if the beam intensity of the reproduction reference beam R′ is uniform during irradiation, then it is considered that the reproduction beam has been received successfully, provided that the detection level of the main beam photosensor 53 obtained when the incidence direction variable irradiator 20 has been moved is equal to or greater than a prescribed value (Vpr), which is higher than the average value (S5: YES). In this, a preferable mode is one in which the received light quantity is a maximum (peak value) as indicated by the central state in FIG. 6. The image of a hologram corresponding to the recording angle θ2 is reproduced on this basis (S6). Thereupon, the operating mechanism returns to S1 again and carries out a similar reproduction operation in order to reproduce an image of a hologram corresponding to the recording angle θ3, for example.

At S3, if the light intensity detected by the first photosensor 51 is greater or lower than the light intensity detected by the second photosensor 52, then a differential signal having a negative level or a positive level is output from the differential amplifier 54 (S3: NO).

In this case, if the differential signal has a negative level, then as indicated by the graph and the example illustrated in (A) in FIG. 6, the projected angle of incidence of the first sub-beam R1 is between the two recording angles θ1 and θ2, the intensity of the first servo beam P1 has a high level, the projected angle of incidence of the second sub-beam R2 is between the two recording angles θ2 and θ3 and the intensity of the second servo beam P2 has a low level. In other words, this is a state where the angle of incidence of the main beam R0 has not reached the recording angle θ2 and the received light quantity in the beam receiving unit 32 is progressively increasing. In a state of this kind, the main portion P0 of the reproduction beam P is not detected with sufficient received light quantity in the beam receiving unit 32 or the main beam photosensor 53. Therefore, the various mechanisms relating to hologram reproduction continue the reproduction operation by returning to S1. By this means, the incidence direction of the reproduction reference beam R′ is continuously changed until the angle of incidence of the main beam R0 coincides with the recording angle θ2.

On the other hand, if the differential signal has a positive level, then as indicated by the graph and the example illustrated in (C) in FIG. 6, the projected angle of incidence of the first sub-beam R1 is between the two recording angles θ1 and θ2, the intensity of the first servo beam P1 has a low level, the projected angle of incidence of the second sub-beam R2 is between the two recording angles θ2 and θ3 and the intensity of the second servo beam P2 has a high level. In other words, this is a state where the angle of incidence of the main beam R0 has traveled past the recording angle θ2 and the received light quantity in the beam receiving unit 32 is progressively decreasing. In a state of this kind also, the main portion P0 of the reproduction beam P is not detected with sufficient received light quantity in the beam receiving unit 32 or the main beam photosensor 53. Therefore, the various mechanisms relating to hologram reproduction continue the reproduction operation by returning to S1. By this means, the incidence direction of the reproduction reference beam R′ is continuously changed until the angle of incidence of the main beam R0 coincides with the next recording angle in the sequence, namely, θ3.

Consequently, according to the hologram reproducing device A of the present embodiment, it is possible to obtain images based on holograms corresponding to the recording angles θ1, θ2 and θ3, just by providing a simple mechanism for generating first and second sub-beams R1 and R2 and detecting the first and second servo beams P1 and P2, and therefore it is possible to carry out a reproduction operation more quickly than in the prior art.

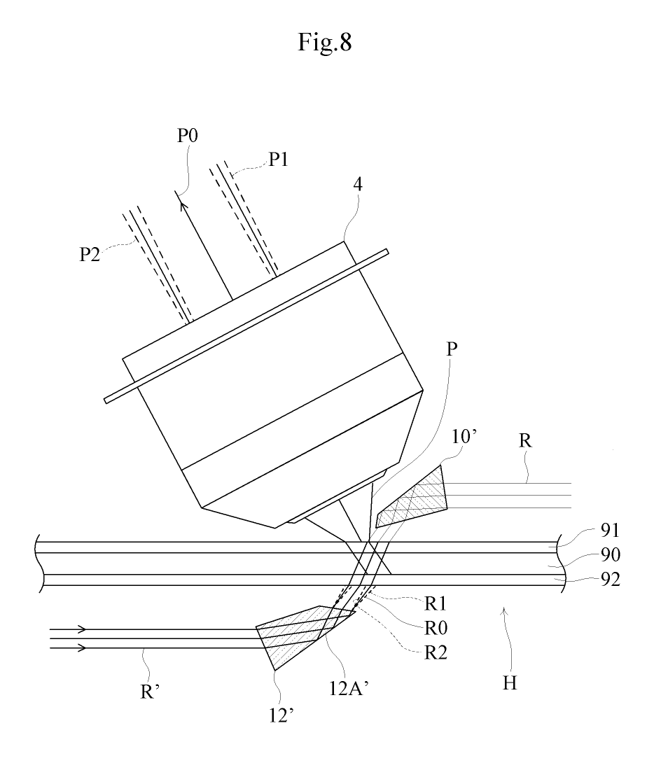

FIG. 8 illustrates a further embodiment of a hologram reproducing device according to the present invention. Elements which are the same as or similar to those of the embodiment described above are labeled with the same reference numerals and further description thereof is omitted here.

In the hologram reproducing device illustrated in FIG. 8, a recording prism 10′ and a reproducing prism 12′ are provided as constituent elements of the incidence direction variable irradiator. The recording prism 10′ is fixed to one end of the arm member (not illustrated) which is disposed on the upper surface side of the hologram recording medium H, and directs the recording reference beam R which has traveled on a light path substantially parallel to the hologram recording medium H, in an oblique downward direction toward a prescribed position. The reproduction prism 12′ is fixed to the other end of the arm member which is disposed on the lower surface side of the hologram recording medium H, and directs the recording reference beam R′ which has traveled on a light path substantially parallel to the hologram recording medium H, in an oblique upward direction toward a prescribed position.

The recording prism 10′ and the reproduction prism 12′ are caused to swing in unison in a Bragg plane (not illustrated). The main axis of the recording reference beam R which is incident on the hologram recording medium H from the recording prism 10′, and the optical axis of the object lens 4, are contained in this Bragg plane Bs. During recording, the recording prism 10′ is made to swing, and in accordance with this, a recording beam S is irradiated each time the angle of incidence of the recording reference beam R becomes a recording angle θ1, θ2, θ3, for example.

A reflective diffraction grating, for example, is formed on a reflective surface 12′A of the reproduction prism 12′, and a reproduction reference beam splitter is realized by this reflective surface 12′A. More specifically, the reproduction reference beam R′ incident on the reproduction prism 12′ is split into a main beam R0 which forms a main incidence direction with respect to the hologram recording medium H and first and second sub-beams R1 and R2 forming incident directions which are spatially shifted from this main beam R0. The main axis of the main beam R0 is contained in the Bragg plane, whereas the main axes of the first and second sub-beams R1 and R2 are not parallel with any of a plane parallel to the hologram recording medium H, or the Bragg plane, or the fractal plane. The reproduction prism 12′ of this kind is caused to swing during reproduction and accordingly, the angle of incidence of the main beam R0 and the projected angles of incidence of the first and second sub-beams R1 and R2 are changed. Similarly to the embodiment described above, the main beam R0 having an incidence direction as illustrated in FIG. 2, and the first and second sub-beams R1 and R2, are produced by the reproduction prism 12′ of this kind.

By forming a diffraction grating on the incident surface and emission surface of the reproduction prism 12′, or by providing a separate prism on the incident surface and the emission surface, it is possible to provide a reproduction reference beam splitter for splitting the light into the main beam R0 and the first and second sub-beams R1 and R2.

It is also possible to achieve a simple structure for generating first and second sub-beams R1 and R2 by means of a hologram reproducing device which includes a reproduction prism 12′ of this kind, and it is possible to accelerate the reproduction operation by detecting the first and second servo beams P1 and P2.

The present invention is not limited to the respective embodiments described above.

For example, the main axes of the sub-beams are contained in the Bragg plane and may be one sub-beam having a prescribed angle of advance with respect to the main beam. In this case, the intensity of the servo beam generated corresponding to the sub-beam is detected, and the angle of incidence of the reproduction reference beam is changed from the time that the intensity of the servo beam becomes a maximum until reaching an angle corresponding to the angle of advance described above. In so doing, the angle of incidence of the main beam reaches a state which precisely matches the recording angle, and a reproduction beam of a sufficient received light level can be obtained.

Furthermore, the light quantity of the sub-beams was taken to be 10% as a proportion of the light quantity of the main beam, but is of course not limited to this. For example, since it is possible to adjust the light quantity of the servo beam corresponding to the sub-beam by shifting the sub-beam in the fractal direction, and furthermore, since the distance between the respective photosensors and the incidence position of the main beam can also be changed by this means, then it is possible to select more optimal design conditions.

1. A hologram reproducing device for reproducing an image based on a hologram: by irradiating a reference beam onto a hologram recording medium on which holograms have been recorded in multiplexed fashion by changing an incidence direction of the reference beam during recording, the incidence direction of the reference beam being changed during reproduction in a similar fashion to during recording; and by receiving a reproduction beam from the hologram recording medium; the hologram reproducing device comprising:
a reproduction reference beam splitter for splitting the reference beam, during reproduction, into a main beam forming a main incidence direction with respect to the hologram recording medium, and sub-beams forming incidence directions spatially shifted from the main beam;
an incidence direction variable irradiator for irradiating the main beam and the sub-beams onto the hologram recording medium while varying the incidence directions of the main beam and the sub-beams;
a servo beam detector for detecting, as servo beams, a portion of the reproduction beam which is generated corresponding to the sub-beams, while an angle of incidence of the main beam and the sub-beams changes;
a beam receiving unit for receiving a main portion of the reproduction beam generated corresponding to the main beam; and
a reproducer for identifying the incidence direction of the main beam at which a received light quantity of the beam receiving unit becomes equal to or greater than a prescribed level, when an intensity of the reference beam is kept uniform, on the basis of servo beam detection results, and reproducing an image obtained by the beam receiving unit when the main beam coincides with the identified incidence direction.

2. The hologram reproducing device according to claim 1, wherein the incidence direction variable irradiator is configured such that the incidence direction of the main beam is varied within a prescribed reference plane which intersects with the hologram recording medium, and the reproduction reference beam splitter is configured so as to generate, as the sub-beams, a first sub-beam and a second sub-beam which are shifted with respect to each other when projected onto the reference plane.

3. The hologram reproducing device according to claim 2, wherein the first sub-beam and the second sub-beam are generated on both sides of the main beam, the main beam being central between same, when projected onto the reference plane.

4. The hologram reproducing device according to claim 3, wherein the first sub-beam and the second sub-beam are also generated on both sides of the main beam, the main beam being central between same, even when projected onto a plane perpendicular to the reference plane.

5. The hologram reproducing device according to claim 3, wherein the servo beam detector comprises a mechanism for carrying out calculation processing using a first photosensor and a second photosensor which detect at the least the intensity of the servo beams corresponding respectively to the first sub-beam and the second sub-beam, and performing feedback control so as to achieve a prescribed target value, as a result of the calculation processing.

6. The hologram reproducing device according to claim 4, wherein the servo beam detector comprises a mechanism for carrying out calculation processing using a first photosensor and a second photosensor which detect at the least the intensity of the servo beams corresponding respectively to the first sub-beam and the second sub-beam, and performing feedback control so as to achieve a prescribed target value, as a result of the calculation processing.

7. The hologram reproducing device according to claim 3, wherein the medium used as the hologram recording medium is a medium on which a hologram has been recorded each time an angle of incidence of the reference beam becomes a prescribed recording angle, recording angles being situated at uniform angular intervals apart, and the angles formed respectively between the main beam and the first sub-beam and the second sub-beam, when the first and second sub-beams are projected to the reference plane, are set to be a different value from the uniform angular interval.

8. The hologram reproducing device according to claim 4, wherein the medium used as the hologram recording medium is a medium on which a hologram has been recorded each time an angle of incidence of the reference beam becomes a prescribed recording angle, recording angles being situated at uniform angular intervals apart, and the angles formed respectively between the main beam and the first sub-beam and the second sub-beam, when the first and second sub-beams are projected to the reference plane, are set to be a different value from the uniform angular interval.

9. The hologram reproducing device according to claim 5, wherein the medium used as the hologram recording medium is a medium on which a hologram has been recorded each time an angle of incidence of the reference beam becomes a prescribed recording angle, recording angles being situated at uniform angular intervals apart, and the angles formed respectively between the main beam and the first sub-beam and the second sub-beam, when the first and second sub-beams are projected to the reference plane, are set to be a different value from the uniform angular interval.

10. The hologram reproducing device according to claim 6, wherein the medium used as the hologram recording medium is a medium on which a hologram has been recorded each time an angle of incidence of the reference beam becomes a prescribed recording angle, recording angles being situated at uniform angular intervals apart, and the angles formed respectively between the main beam and the first sub-beam and the second sub-beam, when the first and second sub-beams are projected to the reference plane, are set to be a different value from the uniform angular interval.

11. A hologram reproducing method for reproducing an image based on a hologram by irradiating a reference beam onto a hologram recording medium on which holograms have been recorded in multiplexed fashion by changing an incidence direction of the reference beam during recording, the incidence direction of the reference beam being changed during reproduction in a similar fashion to during recording, and by receiving a reproduction beam from the hologram recording medium,
the method comprising:
a reproduction reference beam splitting step of splitting the reference beam, during reproduction, into a main beam forming a main incidence direction with respect to the hologram recording medium, and sub-beams forming incidence directions spatially shifted from the main beam within a prescribed reference plane which intersects perpendicularly with the hologram recording medium;
an incidence direction variable irradiation step of irradiating the main beam and the sub-beams onto the hologram recording medium while varying the incidence directions of the main beam and the sub-beams;
a servo beam detection step of detecting a portion of the reproduction beam which is generated corresponding to the sub-beams, while an angle of incidence of the main beam and the sub-beams changes;
a beam receiving step of receiving a main portion of the reproduction beam generated corresponding to the main beam; and
a reproduction step of identifying the incidence direction of the main beam at which a received light quantity in the beam receiving step becomes equal to or greater than a prescribed level, when an intensity of the reference beam is kept uniform, on the basis of servo beam detection results, and reproducing an image obtained by the beam receiving unit when the main beam coincides with the identified incidence direction.
